(19) United States
(12) Patent Application Publication
(10) Pub. No.: US 2008/0243529 A1
(43) Pub. Date: Oct. 2, 2008

(54) Enriched object-based navigation

(76) Inventor: Ilja Fischer, Bad Schonborn (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/728,795

(22) Filed: Mar. 27, 2007

(51) Int. Cl. G06Q 10/00

(52) U.S. Cl. 705/1

(57) ABSTRACT

A system may include reception of a selection of a business object indicator from a user, the business object indicator indicating a business object, determination of an operation based on the business object, determination of a number of results associated with the operation, and definition of a context menu for display in association with the business object indicator, the context menu indicating the operation and the number of results.

### FIELD

Some embodiments relate to user interfaces for presenting data stored in a database. In particular, some embodiments concern presentation of data relating to stored business objects.

### BACKGROUND

Object-Based Navigation (hereinafter “OBN”), described in U.S. Patent Application Publication No. 2005/0288945, facilitates role-based presentation of back-end data within a-web browser. For example, a web page may include a link representing a business object stored in a back-end system. A user may select the link and, in response, may be presented with a menu of selectable operation indicators associated with the business object and based on a role of the user. Selecting one of the selectable operation indicators causes the display of associated data in a particular format. In this regard, the data and the format may also be based on a role of the user.

FIG. 1A illustrates an OBN process according to some conventional systems. Window 100 represents main window 100 of a web browsing application executing within a client device. The web browsing application has transmitted a request for page 105 to a web server providing OBN services. The web browsing application receives and displays page 105 as shown in FIG. 1A. A user of the client device has manipulated navigation pane 110 to expand the heading “Contacts” and to select sub-heading 115 “Business Partners”. Page 105 therefore includes table 120 showing information corresponding to three business partners.

As described in the aforementioned patent application publication, the web browsing application may display table 120 by executing a code snippet received from the web server providing OBN services. The code snippet allows the client device to dynamically retrieve content and to display the content in a desired format.

Continuing with the illustrated example, the user has selected link 125 (“IBM”) to cause display of context menu 130. In some systems, such selection may comprise clicking a right mouse button while a cursor is located on link 125. Context menu 130 includes selectable operation indicators (or, OBN links) associated with the business object underlying link 125. The code snippet associated with table 120 may determine the content and display of context menu 130 based on a role of the user.

The code snippet may also identify a new view to display upon selection of an indicator such as indicator 135 “Show new contracts”. In particular, selection of indicator 135 may cause execution of a second code snippet based on the selected operation and the user role. The second code snippet may dynamically retrieve associated content and display the content in a desired format. In the present example, the second code snippet is associated with a query to retrieve back-end data associated with all new contracts associated with the business object underlying link 125.

FIG.1 B shows table 140 displayed in window 100 in response to selection of operation 135. The lack of data within table 140 indicates that the query returned no data because no new contracts are associated with the business object. Unfortunately, the user was forced to select indicator 135 and to view table 140 in order to determine that no new contracts are associated with the business object.

Systems are desired to further facilitate efficient browsing of back-end data using object-based navigation techniques.

### BRIEF DESCRIPTION OF THE DRAWINGS

FIGS. 1A and 1B comprise outward views of a prior art user interface.

FIG. 2 is an outward view of a user interface according to some embodiments.

FIG. 3 is an outward view of a user interface according to some embodiments.

FIG. 4 is a block diagram of a system to provide a user interface according to some embodiments.

FIG. 5 is a flow diagram of a process according to some embodiments.

FIG. 6 is a block diagram of a hardware system according to some embodiments.

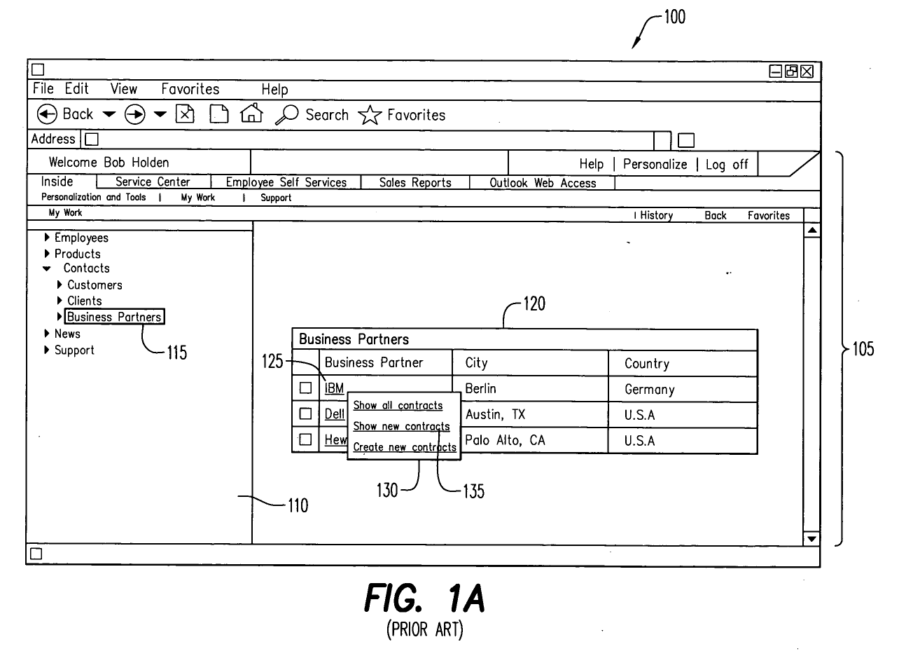

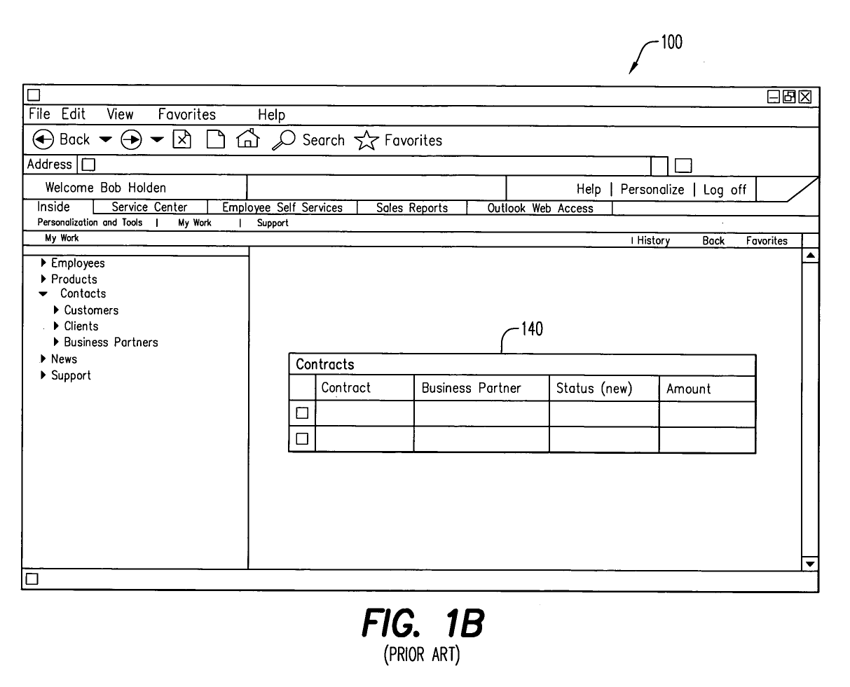

### DETAILED DESCRIPTION

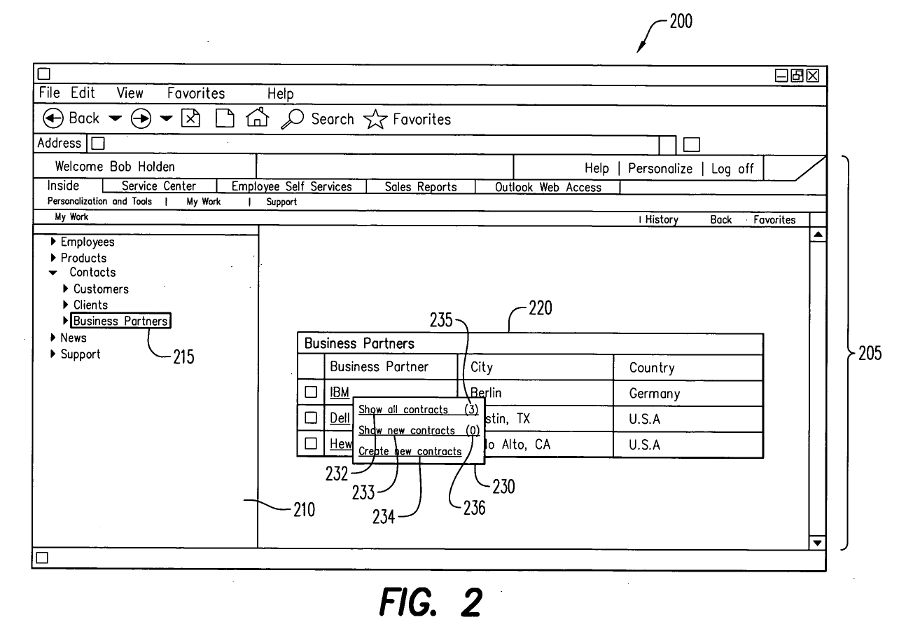

FIG. 2 is an outward view of user interface 200 according to some embodiments. User interface 200 may be presented by any suitable display device in communication with any suitable client device. Generally, a client device may execute processor-executable program code to cause a display device to present user interface 200.

In some embodiments, user interface 200 comprises a main window of a web browsing application displayed on a flat panel LCD monitor coupled to a desktop computer. Examples of other client devices include, but are not limited to, a laptop computer, a personal digital assistant, a cellular telephone, and a tablet-based personal computer.

User interface 200 represents a generic web browsing application but embodiments are not limited thereto. User interface 200 may be associated with any suitable client application that is or becomes known. In some embodiments, the client application provides rendering of markup language-formatted pages as well as execution of scripts associated with the pages.

User interface 200 presents page 205 and navigation pane 210, which includes a tree of page headings. One page heading has been expanded to display sub-heading 215 “Business Partners”. Sub-heading 215 has been selected, resulting in display of page 205 including table 220.

In more detail, selection of sub-heading 215 has caused the web browsing application to transmit a HyperText Transfer Protocol (HTTP) request for an associated page to the World Wide Web. The request is received by a web server associated with the requested page. Examples of a web server according to some embodiments will be described below.

Page 205 is returned by the web server and may comprise any data format(s) from which a page may be rendered. In some embodiments, page 205 comprises HyperText Markup Language (HTML) data and is associated with Javascript code that may also be received from the web server. For example, the web browsing application may render table 220 by executing Javascript code associated with the area of page 205 in which table 220 resides. The Javascript code may thereby allow the client device to dynamically retrieve back-end data and to display the data in table 220. Embodiments are not limited to Javascript or HTML.

The user has selected (e.g., right-clicked) link 225 (“IBM”), resulting in display of context menu 230. Context menu 230 includes selectable operation indicators 232, 233 and 234 indicating operations associated with the business object underlying link 225. As described in U.S. Patent Application Publication No. 2005/0288945, the contents of which are incorporated by reference herein for all purposes, the Javascript or other type of code snippet associated with table 220 may determine the selectable operation indicators to display within context menu 230 based on predefined associations between the business object, the operations and a role of the user.

Selectable operation indicator 232 is presented in association with number of results 235. Similarly, selectable operation indicator 233 is presented in association with number of results 236. According to some embodiments, the number of results associated with a selectable operation indicator reflects a number of results returned by a query that is associated with an operation indicated by the selectable operation indicator.

More particularly, number of results 236 indicates that no results were returned by a query associated with an operation indicated by indicator 233. A user may therefore determine to forego selecting indicator 233 because the user is aware that no query results are associated with the associated operation. In contrast, selectable operation indicator 232 is selectable to cause display of the three query results associated with the associated operation as described above.

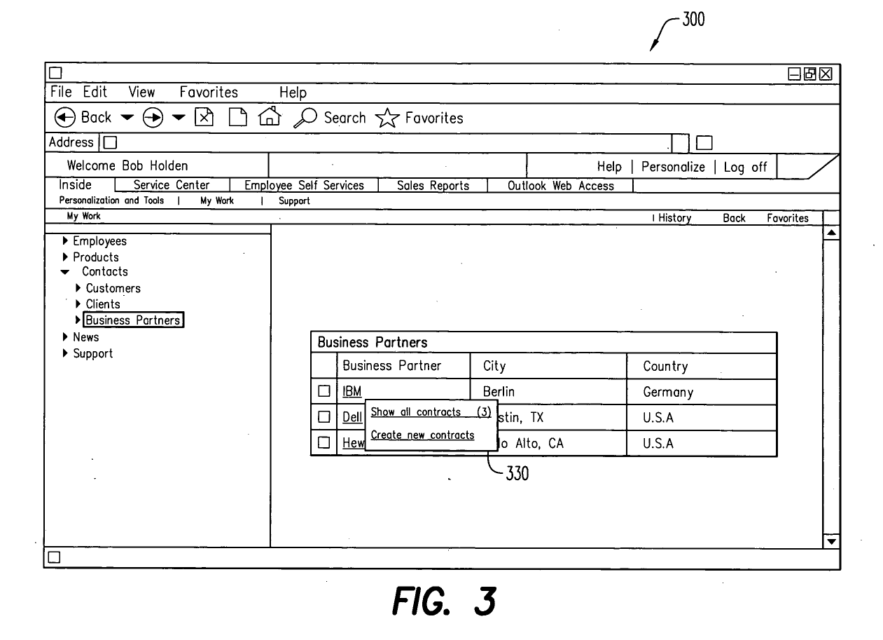

FIG. 3 is an outward view of user interface 300 according to some embodiments. User interface 300 may conform to any number of the details set forth above with respect to user interface 200. User interface 300 is identical to user interface 200 but does not include a selectable operation indicator analogous to indicator 233 of interface 200.

Such an analogous indicator is lacking from context menu 330 because, during the definition of context menu 330, it was determined that no query results are associated with the “Show new contracts” operation. Accordingly, user interface 300 may prevent a user from selecting a selectable operation indicator with which no query results are associated. Definition of a context menu such as context menu 330 according to some embodiments will be described in detail below.

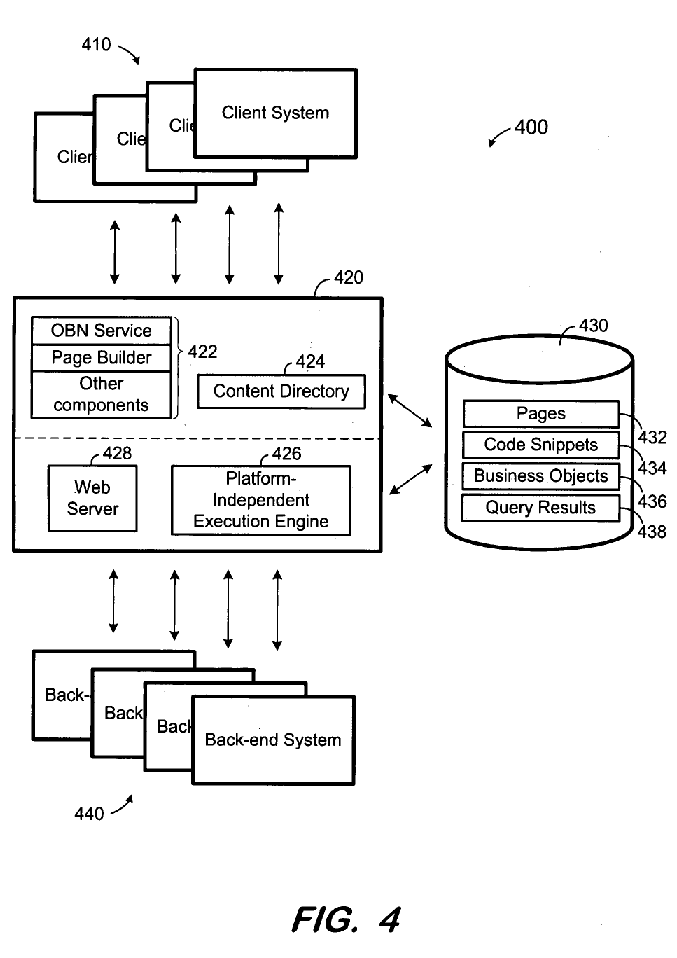

FIG. 4 is a block diagram of system 400 according to some embodiments. System 400 comprises client systems 410, server 420, server database 430 and back-end systems 440. Generally, server 420 and server database 430 may provide client systems 410 with access to data of back-end systems 440. Other topologies may be used in conjunction with other embodiments.

Client systems 410 may comprise any number of discrete or variously interconnected systems. As described above, client systems 410 may comprise one or more desktop computers, personal digital assistants, cellular telephones, laptop computers, or other suitable devices. Each of client systems 410 may communicate with server 420 via a network (e.g. the Internet) and/or a dedicated connection. In this regard, the elements of system 400 may be located remote from one another and may each comprise any number of hardware and/or software elements suitable to provide the functions described herein, some of which are located remote from each other.

Server 420 receives requests from client systems 410 and returns data for display on client systems 410. Server 420 may thereby provide client systems 410 with a consolidated access point to various information sources, applications, repositories, databases and services. Server 420 may, in some embodiments, operate to receive a selection of a business object indicator from a user, the business object indicator indicating a business object. Server 420 may determine an operation based on the business object, determine a number of results associated with the operation, and define a context menu for display in association with the business object indicator. The defined context menu indicates the operation and the number of results.

According to the illustrated embodiment, server 420 comprises components 422 and content directory 424. Components 422 may comprise program code (e.g., Java) that is executable according to user requests and to generate a page (e.g., HTML) for transmission to client systems 410. OBN service component 422, for example, may comprise program code to determine operations based on business objects and user roles, and/or to define context menus of a page as described herein. Page builder component 422 may be executable to assemble the content of a page according to a defined page layout. Server 422 may also include other components 422 for performing other tasks.

Content directory 424 may comprise an interface between components 422 and database 430. Content directory 424 therefore stores and retrieves data including, but not limited to, pages 432, code snippets 434, business objects 436 and query results 438 from database 430. Pages 432 may comprise HTML data, code snippets (e.g., iViews) and/or other pages organized in a layout. A page 432 may be associated with a particular set of user roles authorized to view the page 432. Each of code snippets 434 may comprise a set of properties used at runtime to parameterize the component 422 on which the code snippet is based. Page builder component 422 may assemble content of pages 432 using code snippets 432 and their related components 422 during runtime.

Server 420 also includes web server 428 to support HTTP and secure HTTP communication with client systems 410. Additionally, platform-independent execution engine may provide an execution environment for compatible program code of server 420. For example, one or more of components 422, content directory 424 and code snippets 434 may be written in Java and engine 426 may comprise a Java 2 Enterprise Edition (J2EE) execution engine. According to some embodiments, server 420 comprises program code of SAP Enterprise Portal® and SAP Web Application Server®.

Returning to database 430, business objects 436 may encapsulate data from back-end systems 440. Business objects 436 may be imported to database 430 to allow association of business objects 436 with operations and user roles. One or more of business objects 436 may be associated with one or more code snippets 434 for retrieval and display of data associated with the one or more of business objects 436.

Query results 438 may comprise results of queries previously submitted to back-end systems 440. These queries may be associated with operations that are in turn associated with business objects as described above. Using the example of FIG. 2, a query “GetNewContractsforBusinessPartner” may be associated with the operation indicated by operation indicator 233. As will be described below, the aforementioned query may be submitted periodically to back-end systems 440 and the returned results may be stored among query results 438.

Back-end systems 440 may store data of the business objects mentioned herein. Systems 440 may comprise any data sources from which server 420 may receive data. According to some embodiments, server 420 comprises software connectors to several different types of data sources. For example, server 420 may support any of the protocols in the following non-exhaustive list: Java Database Connectivity (JDBC), SAP Java Connector (JCO), P4, and Simple Object Access Protocol (SOAP). Back-end systems 440 may therefore comprise a relational database in direct communication with server 420 via a Structured Query Language (SQL) interface or systems which provide intermediary “business intelligence” to data stored within such databases.

One or more of back-end systems 440 may comprise a back-end data environment employed in a business or industrial context. Back-end systems 440 may therefore comprise many disparate hardware and software systems, some of which are not interoperational with one another.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

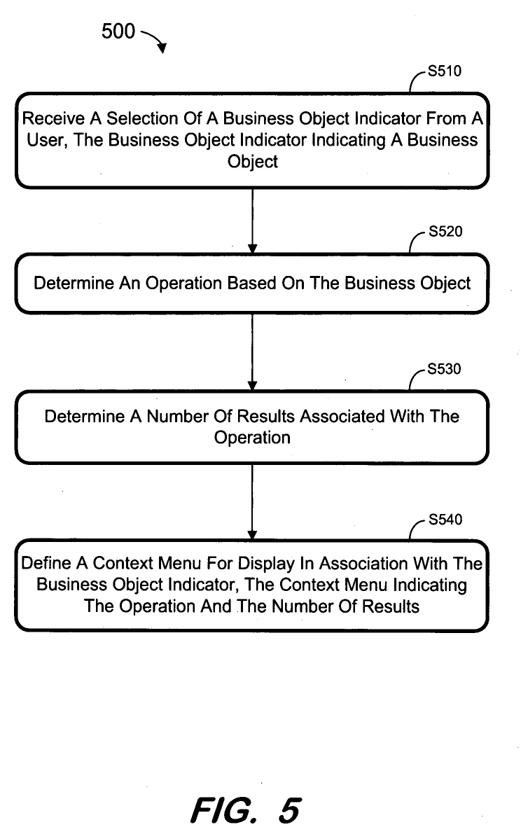

FIG. 5 is a flow diagram of process 500 according to some embodiments. Some embodiments of process 500 may provide enriched object-based navigation as described above with respect to FIGS. 2 and 3. In some embodiments, server 420 executes program code to perform process 500.

In this regard, process 500 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, a selection of a business object indicator is received from a user at S510. The selected business object indicator indicates a business object. From the user standpoint, selection of the business object indicator may comprise right-clicking upon business object indicator 225 of FIG. 2. In response, an event within page 205 and associated with indicator 225 triggers the transmission of a request to server 420. The received request indicates the selection of business object indicator 225.

At S520, an operation is determined based on the business object indicated by the selected business object indicator. According to some embodiments of 520, server 420 transmits an event in response to the received request. The event is transmitted to an iView of database 430 which is associated with the business object. An iView event handler then launches OBN service 422, which in turn calls a role API to acquire all iViews implementing all operations associated with the business object. The acquired information is returned to the iView event handler.

The iView event handler determines which of the operations associated with the business object is also associated with the current user's role. The current user may possess more than one role, in which case the iView event handler may determine operations associated with each of the current user's roles. The preceding discussion of S520 is in accordance with object-based navigation techniques known to those in the art.

Next, and unlike prior systems, a number of results associated with a determined operation is determined at S530. The number of results may reflect a number of results returned from a query associated with the operation. However, the operation may be associated with one or more queries. Accordingly, the determined number of results is based on a query associated with the operation and with the role of the user.

Returning to the FIG. 2 example, it will be assumed that the query “GetNewContractsforBusinessPartner” is associated with the determined operation and the current user's role. At S530, the query may be submitted to back-end systems 440 in association with the business object and the number of results may be determined based on the returned results.

Alternatively, the results of such a query may be stored among query results 438 prior to execution of process 500. A maintenance process of server 420, for example, may execute queries associated with each operation of business objects 436 and store the returned results during periods of relative inactivity (e.g., evenings, weekends, etc.). The results of a query may be stored among query results 438 in association with a business object, an operation, and a user role. The number of results associated with the determined operation may therefore be determined from stored query results 438.

According to some embodiments, two or more operations may be determined to be associated with the business object at S520. A number of results associated with each of the two or more operations may be determined at S530 as described above.

A context menu is defined for display in association with the business object indicator at S540. The context menu indicates the determined operation and the determined number of results. Examples of such a context menu are illustrated in FIGS. 2 and 3.

In more detail, server 420 may generate the data required by the client system to render a context menu indicating the determined operation and the determined number of results. The data may comprise parameters of a portal component, HTML data, and/or any other suitable and renderable data. In a case that a number of results associated with each of two or more operations were determined at S530, the context menu may indicate each determined operation and each determined number of results. According to some embodiments such as that illustrated in FIG. 3, the context menu does not indicate a determined operation which is associated with no results.

After process 500, the user may select any operation indicator of the context menu to receive results of a query associated with the operation indicated by the operation indicator. Such selection and reception may proceed according to conventional object-based navigation techniques.

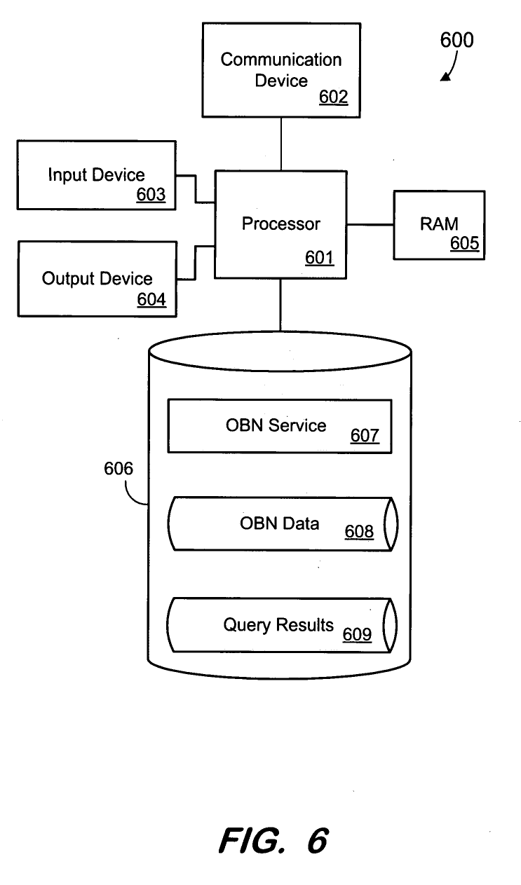

FIG. 6 is a block diagram of an internal architecture of an apparatus according to some embodiments. Apparatus 600 may embody one or more elements of server 420 in some embodiments. Apparatus 600 includes processor 601 to execute processor-executable program code so as to control the elements of apparatus 600 to provide functionality such as that described herein.

Communication device 602 is in communication with processor 601. Communication device 602 is used to transmit data to and to receive data from devices external to apparatus 600 such as client device 410 and back-end systems 440. Communication device 602 is therefore preferably configured with hardware suitable to physically interface with desired external devices and/or network connections. For example, communication device 602 may comprise an Ethernet connection to a local area network through which apparatus 600 may receive and transmit information over the Web.

Input device 603 and output device 604 are also in communication with processor 601. Any known input device may comprise input device 603, including a keyboard, mouse, touch pad, voice-recognition system, or any combination of these devices. Of course, information may also be input to apparatus 600 via communication device 602. Output device 603 may be an integral or separate CRT display, flat-panel display or the like used to present graphics and text in response to commands issued by processor 601.

RAM 605 provides processor 601 with fast data storage and retrieval. In this regard, processor-executable program code being executed by processor 601 is typically stored temporarily in RAM 605 and executed therefrom by processor 601.

Data storage device 606 stores, among other data, processor-executable program code of OBN service 607. Apparatus 600 may execute OBN service 607 to provide the functions described herein. OBN service 607 may use stored OBN data 608 to provide such functions. In this regard, stored OBN data 608 may specify operations and roles associated with business objects, and queries associated with the operations and roles. Query results 609 may store the results of the queries for use as described above. OBN service 607 may comprise a Java application, an ABAP application, or any application suitable for the operating system of apparatus 600.

Data storage device 606 may also include processor-executable program code of other applications for execution by apparatus 600. Data storage device 606 may also store process steps of an operating system (unshown). An operating system provides a platform for executing applications, device drivers and other process steps that interact with elements of apparatus 600.

The embodiments described herein are solely for the purpose of illustration. Those in the art will recognize other embodiments may be practiced with modifications and alterations limited only by the claims.

What is claimed is:

1. A method comprising:
receiving a selection of a business object indicator from a user, the business object indicator indicating a business object;
determining an operation based on the business object;
determining a number of results associated with the operation; and
defining a context menu for display in association with the business object indicator, the context menu indicating the operation and the number of results.

2. A method according to claim 1, wherein determining the operation comprises:
determining the operation based on the business object and a role of the user.

3. A method according to claim 1, further comprising:
determining a second operation based on the business object; and
determining a second number of results associated with the second operation,
wherein the defined context menu indicates the second operation and the second number of results.

4. A method according to claim 1, further comprising:
determining a second operation based on the business object; and
determining that no results are associated with the second operation,
wherein the defined context menu indicates the operation and the number of results, and does not indicate the second operation.

5. A medium storing processor-executable program code, the program code comprising:
code to receive a selection of a business object indicator from a user, the business object indicator indicating a business object;
code to determine an operation based on the business object;
code to determine a number of results associated with the operation; and
code to define a context menu for display in association with the business object indicator, the context menu indicating the operation and the number of results.

6. A medium according to claim 5, wherein the program code to determine the operation comprises:
code to determine the operation based on the business object and a role of the user.

7. A medium according to claim 5, the program code further comprising:
code to determine a second operation based on the business object; and
code to determine a second number of results associated with the second operation,
wherein the defined context menu indicates the second operation and the second number of results.

8. A medium according to claim 5, the program code further comprising:
code to determine a second operation based on the business object; and
code to determine that no results are associated with the second operation,
wherein the defined context menu indicates the operation and the number of results, and does not indicate the second operation.

9. A system comprising:
a server to
receive a selection of a business object indicator from a user, the business object indicator indicating a business object,
determine an operation based on the business object;
determine a number of results associated with the operation, and
define a context menu for display in association with the business object indicator, the context menu indicating the operation and the number of results.

10. A system according to claim 9, further comprising:
a database to store the number of results and to store data to define the context menu.

11. A system according to claim 9, further comprising:
a back-end system to store the business object.

12. A system according to claim 9, wherein determination of the operation comprises determination of the operation based on the business object and a role of the user.

13. A system according to claim 9, the server further to
determine a second operation based on the business object; and
determine a second number of results associated with the second operation,
wherein the defined context menu indicates the second operation and the second number of results.

14. A system according to claim 9, the server further to:
determine a second operation based on the business object; and
determine that no results are associated with the second operation,
wherein the defined context menu indicates the operation and the number of results, and does not indicate the second operation.

15. A medium storing processor-executable program code, the program code comprising:
code to present a user interface, the user interface comprising:
a selectable business object indicator indicating a business object; and
a context menu displayed in association with the business object indicator in response to selection of the business object indicator,
wherein the context menu displays a selectable operation indicator indicating an operation associated with the business object and displays a number of results associated with the operation.

16. A medium according to claim 15, wherein the displayed operation is based on the business object and a role of the user.

17. A medium according to claim 15, wherein the context menu displays a second selectable operation indicator indicating a second operation associated with the business object and displays a second number of results associated with the second operation.

18. A medium according to claim 15, wherein the number of results comprises a number of results returned by a query associated with the operation.

19. A medium according to claim 15, wherein the operation indicator is selectable to cause the user interface to display the results associated with the operation.
